(19) United States
(12) Patent Application Publication
(10) Pub. No.: US 2016/0260164 A1
(43) Pub. Date: Sep. 8, 2016

(54) COMPUTER PROGRAM, SYSTEM, AND METHOD FOR SELLING ITEMS

(71) Applicants: Alec Prostok, Houston, TX (US); Steven Duffy Schwartz, Chicago, IL (US)

(72) Inventors: Alec Prostok, Houston, TX (US); Steven Duffy Schwartz, Chicago, IL (US)

(21) Appl. No.: 14/635,707

(22) Filed: Mar. 2, 2015

(51) Int. Cl. G06Q 30/08; G06Q 30/02

(52) U.S. Cl. CPC G06Q 30/08; G06Q 30/0213; G06Q 30/0222

(57) ABSTRACT

A non-transitory computer readable medium with a computer program stored thereon for controlling operation of a computer system to implement a website for selling items via the Internet. The website presents information about a plurality of items for sale. The information includes at least a description and an initial price for each item. The website permits a user to select an item from the website and enter a bid process for the selected item. The website collects an entry fee from the user for the bid process. The website then deducts at least a portion of the entry fee from the initial price of the selected item to determine a reduced price for the selected item and displays the reduced price for the item on the website. These steps are then repeated each time another user enters the bid process for the selected item. The website then permits any one, but only one, of the users who entered the bid process and paid the entry fee to purchase the selected product at the reduced price.

### BACKGROUND

The present invention relates to methods and systems for selling products, services, and other items via the Internet.

Many studies have shown that a primary reason consumers purchase products, services, and other items via the Internet is to obtain the lowest purchase price possible. Unlike conventional “bricks and mortar” shopping at physical stores, the Internet allows consumers to quickly and easily compare the prices of items from numerous vendors and then buy an item from the least expensive vendor.

Unfortunately, the actual savings realized by shopping on-line is often not as great as hoped because many on-line retailers sell items at the same or similar price due to minimum sales prices imposed by the manufacturers of the products. Such minimum prices are sometimes referred to as “Manufacturer Suggested Retail Price” (MSRP) or “Minimum Sales Price” (MSP). Even when manufacturers don't impose minimum sales prices, on-line retailers often sell at similar prices because they have similar expenses.

Consumers can sometimes find good deals through on-line auctions, reverse auctions and the like, but such auctions are primarily designed for selling unique and/or one-off items such as real estate, hotel rooms, cars, used products, etc. and don't work as well for new products and/or commodity items such as consumer electronics, clothing, etc.

### SUMMARY

The present invention solves the above-described problems by providing improved methods, computer programs, and systems for selling and purchasing products, services, and other items via the Internet.

An embodiment of the invention is at least partially implemented by a computer program that operates a computer system. The computer system hosts a website that may be accessed by users with computing devices such as personal computers or smart phones.

In one embodiment, the website presents information about a number of items that are being offered for sale so that users may determine whether they wish to purchase any of the items. The information may include anything that helps a user decide whether he or she wishes to purchase an item. For example, if the items are products such as consumer electronic devices, the information may include a photo or image of each item, a description of each item, and an initial price for each item. The initial price may be the full retail price of the item or any other non-discounted price.

A user may then select an item the user wishes to purchase. The user is then invited to enter a bid process for the selected item. As part of the bid process, the user is required to pay an entry fee. The entry fee may be a fixed amount such as $5 or may be a percentage of the full retail price of the item such as 5%.

If the user enters the bid process and agrees to pay the entry fee, the website deducts at least a portion of the entry fee from the initial price of the selected item to determine a reduced price for the selected item. For example, if the selected item is a laptop computer with a retail price of $2,000 and the entry fee is $10, the website may deduct $10 from the retail price to arrive at a reduced price of $1,990. The website then displays the reduced price for the selected product.

In some embodiments, the full entry fee from each user who enters the bid process deducted from the initial price of the item. In other embodiments, only a portion of the entry fee is deducted from the initial price of the item, and the remainder is kept by the operator of the website to cover expenses and profits. In still other embodiments, the full entry fee plus a bonus amount may be deducted from the initial price of the item. For example, a $10 entry fee and a $1 bonus amount may be deducted from the initial price to determine the reduced price. The bonus amount may be used to provide further incentives to purchase items and may be paid for from advertising revenues or other revenues the operator of the website receives from manufacturers.

The method then repeats the steps described above each time another user enters the bid process for the selected product. For example, if a second user enters the bid process for the same laptop computer mentioned above, the website charges the second user a $10 entry fee and then subtracts this entry fee from the already reduced price for the laptop to arrive at a new reduced price of $1,980. Each time another user enters the bid process for the laptop computer, the price of the laptop is reduced by another $10 or other amount as described above. Thus, as more users elect to enter the bid process, the price of the laptop goes down.

At any time during the bid process, any one, but only one, of the users who entered the bid process and paid the entry fee may elect to purchase the selected item at the reduced price. Continuing the laptop example from above, the first user who entered the bid price may purchase the laptop for $1,990 before any other users enter the bid process. After the second user enters the bid process, the first or second user may purchase the laptop for $1,980 until yet another user enters the bid process, and so on. Thus, users must monitor the reduced price of the item and decide whether to buy it at the current price or wait in hopes that others will enter the bid process and cause the price to be reduced further. The users must of course weigh the benefits of waiting against the risks that another user will purchase the item first.

If one of the users who entered the bid process and paid the entry fee elects to purchase the selected item at the reduced price, the website facilitates the sale of the item to the user and then removes the item from the bid process. If other users decide they want to bid on the item again, they must initiate a new bid process and pay another entry fee. Thus, the entry fees of all the users who enter a bid process are used to reduce the purchase price of the item for the one purchaser. This can result in a significant price reduction for an item and thus encourage other users to start another bid process. The website may also advertise or otherwise display the final reduced price at which an item is sold to encourage more users to initiate a bid process.

In some embodiments, the item is removed from the bid process if none of the users elect to purchase the item within a prescribed time period. In this embodiment, the website may initiate a count-down of the prescribed time period once the first user enters the bid process and may display the countdown to encourage users to purchase the item before the time expires. If no one purchases the item, the entry fees may be fully or partially refunded.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of exemplary computer and communication equipment that may be used to implement embodiments of the present invention.

FIG. 2 is a flow chart showing exemplary steps in a method embodiment of the present invention and/or functions performed by a computer program embodiment of the invention.

FIG. 3 is another flow chart showing exemplary steps in a method embodiment of the present invention and/or functions performed by a computer program embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the invention include methods, systems, and computer programs for selling items via the Internet. One embodiment of the invention may be at least partially implemented by one or more computer programs that operate a computer system so as to host a website accessible by users via the Internet or other communications network. The website may be operated by a manufacturer or an agent of a manufacturer to sell products from that manufacturer only. For example, the website may be operated by or for Apple or IBM to sell Apple or IBM products. The website may also be operated by or for a third party seller of products from many different manufacturers.

Although the invention is especially suited for selling products such as consumer electronics, it works equally well for selling all types of products, services, and other items. As used herein, the term “item” or “items” is meant to encompass any products, services, and/or other things that can be sold via the Internet.

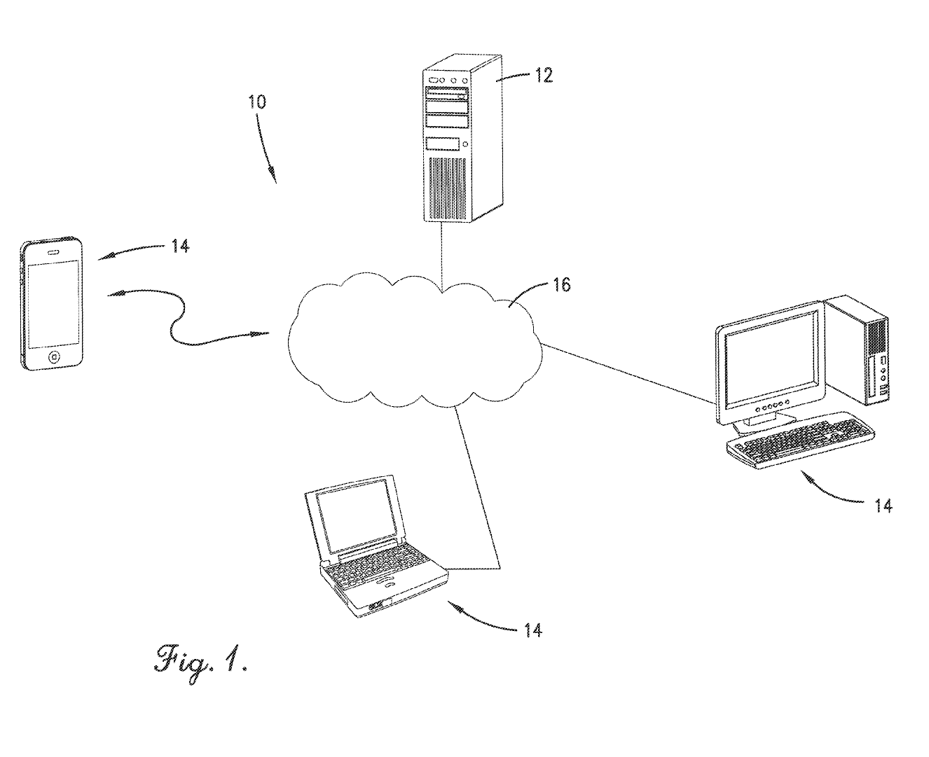

Turning now to the drawing figures, a computer and communications system 10 is shown in FIG. 1 that may be used to implement aspects of the invention. One embodiment of the system 10 includes a computer or computer system 12 that may be accessed by one more personal computing devices 14 via a communications network 16. The devices in the system 10 may be operated by any persons or entities.

The computer system 12, and/or another computer system in communication with the computer system 12, implements the website described herein and may be accessed by the devices 14. The computer system 12 may operate one or more computer programs for performing some of the functions described herein as described below.

Embodiments of the computer system 12 may include one or more servers running Windows; LAMP (Linux, Apache HTTP server, MySQL, and PHP/Perl/Python); Java; AJAX; NT; Novel Netware; Unix; or any other software system. The computer system 12 includes or has access to computer memory and other hardware and software for receiving, storing, accessing, and transmitting information as described below. The computer system 12 may also include conventional web hosting operating software, searching algorithms, an Internet connection, and is assigned a URL and corresponding domain name so that it can be accessed via the Internet in a conventional manner.

The personal computing devices 14 are operated by users who wish to access the website implemented by the computer system 12. The devices 14 may be any combination of desktop computers, laptop computers, tablet computers, mobile phones, or any other electronic devices capable of communicating with the computer system 12. Each personal computing device preferably includes or can access an Internet browser and a conventional Internet connection such as a wireless broadband connection, DSL converter, or ISDN converter so that it can exchange data with the computer system 12 via the communications network 16.

The communications network 16 may be the Internet or any other communications network such as a local area network, a wide area network, or an intranet. The communications network 16 may include or be in communication with a wireless network capable of supporting wireless communications such as the wireless networks operated by AT&T, Verizon, or Sprint. The wireless network may include conventional switching and routing equipment. The communications network 16 and wireless network may also be combined or implemented with several different networks.

The components of the system 10 illustrated and described herein are merely examples of equipment that may be used to implement embodiments of the present invention and may be replaced with other equipment without departing from the scope of the present invention. Some of the illustrated components of the system 10 may also be combined.

Aspects of the present invention may also be implemented with one or more computer programs stored in or on computer-readable medium residing on or accessible by the computer system 12, the personal computing devices 14, or other electronic devices in communication with these devices. The computer programs may comprise listings of executable instructions for implementing logical functions in the computers and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

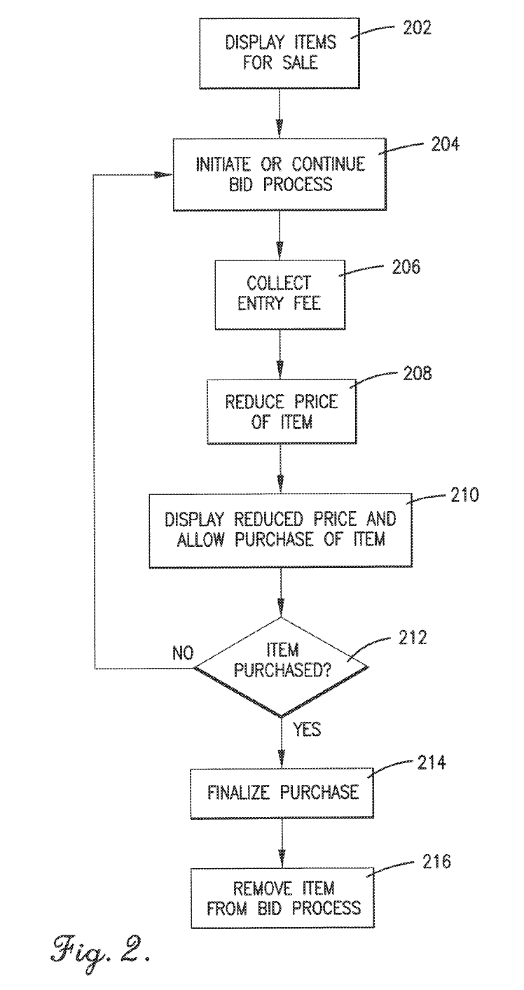

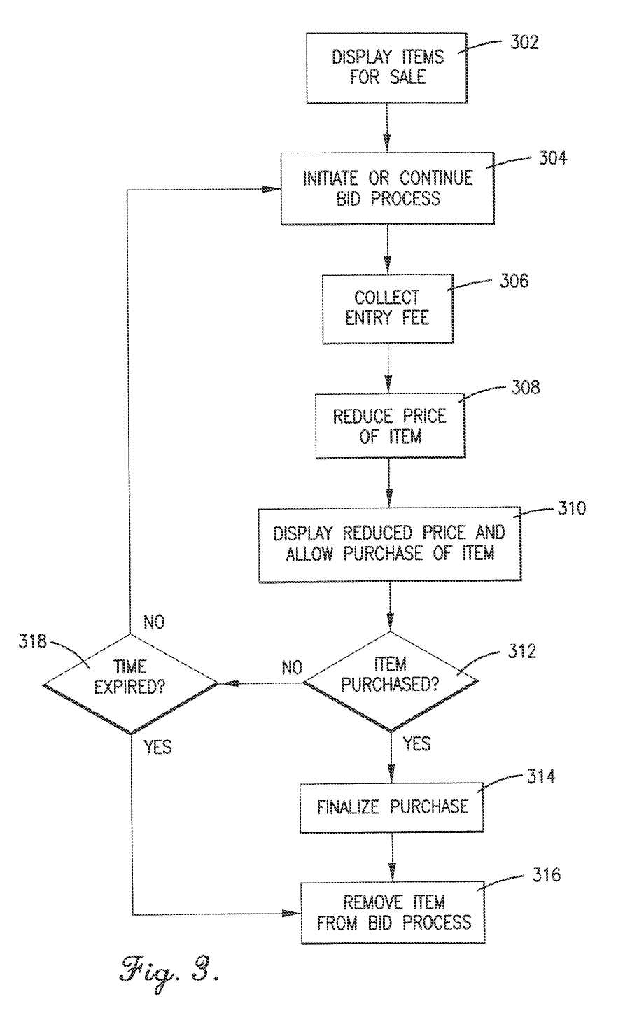

The flow charts of FIGS. 2 and 3 show the functionality and operation of exemplary implementations of the present invention in more detail. In this regard, some of the blocks of the flow charts may represent steps in a method of selling items in accordance with aspects of the present invention and/or a module segment or portion of code of the computer programs of the present invention. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

Turning now to FIG. 2, the website described above may present information about a number of items for sale so that users may determine whether they wish to purchase any of the items as depicted in box 202. The information may include anything that helps a user decide whether he or she wishes to purchase an item. For example, if the items are laptop computers, the information may include a photo or image of each laptop computer being offered for sale, a description of each computer, and an initial price for each computer. The initial price may be the full retail price of the computer or some other non-discounted price of the computer.

Any user who may then select an item from the website. The user is then invited to enter a bid process for the selected item as depicted in box 204. For example, a user may click-on a photo or title of an item and be directed to a screen that describes the bid process of the present invention and invites the user to participate.

As part of the bid process, the user is required to pay an entry fee as depicted in box 206. The entry fee may be a fixed amount such as $1, $5, $10 or any other amount or may be a percentage of the full retail price of the item such as 1%, 2% or any other percentage. The website may collect the entry fee in any conventional manner such as via a credit card payment.

The website then deducts at least a portion of the entry fee from the initial price of the selected item to determine a reduced price for the selected item as depicted in box 208. For example, if the selected item is a laptop computer with a retail price of $2,000 and the entry fee is $10, the website may deduct $10 from the retail price to arrive at a reduced price of $1,990.

In some embodiments, the full entry fee is deducted from the initial price of the item. In other embodiments, only a portion of the entry fee is deducted from the initial price of the item and the remainder is kept by the operator of the website to cover expenses and profits. In still other embodiments, the full entry fee plus a bonus amount may be deducted from the initial price of the item. For example, a $10 entry fee and a $1 bonus amount may be deducted. The bonus amount may be used to provide further incentives to purchase items as described in more detail below and may be paid for from advertising revenues or other revenues the operator of the website receives from manufacturers.

The website then displays the reduced price for the selected product and allows any user who has already entered the bid process to purchase the item as depicted in box 210. At this point in this description, only one user has entered the bid process so only that one user may purchase the item at the current reduced price. If the user elects to purchase the item, the website facilitates the sale as depicted in blocks 212 and 214.

However, the first user who enters the bid price doesn't purchase the item at the reduced price, other users may enter the bid process for the same item as depicted by boxes 212 and 204. Each time another user enters the bid process, an entry fee is collected and at least partially deducted from the price of the item. For example, if the item is a laptop computer with an initial price of $2,000, the entry fee to enter the bid process is $10, and the full amount of the entry fee is deducted from the initial price, the price of the laptop is reduced $10 for each user who enters the bid process. Thus, if 20 users enter the bid process before the laptop is purchased, the price is reduced to $1,800. If 100 users enter the bid process, the price is reduced to $1,000. Thus, as more users elect to enter the bid process, the price of the laptop goes down.

At any time during the bid process, any one, but only one, of the users who has already entered the bid process and paid the entry fee may elect to purchase the selected product at the reduced price as depicted in boxes 212 and 214. Thus, users must monitor the price of the item and decide whether to buy it at the current price or wait in hopes that the price falls further. The users must therefore weigh the benefits of waiting for a lower price versus the risks that another user may purchase the item first.

If one of the users who entered the bid process and paid the entry fee elects to purchase the selected product at the reduced price, the website removes the item from the bid process as depicted in box 216. If other users decide they want to bid on the item again, they must initiate a new bid process and pay another entry fee. The website may also advertise or otherwise display the final reduced price at which an item is sold to encourage more users to initiate a bid process.

If no user elects to purchase the item at the current reduced price, the computer system may terminate the bid process or keep it open indefinitely. If no one purchases the item, the entry fees may be fully or partially refunded.

The flow chart of FIG. 3 shows the functionality and operation of another implementation of the present invention. In this embodiment, the steps depicted by boxes 302-316 are the same as the steps depicted by boxes 202-216 in FIG. 2. However, this embodiment adds a time limit to each bid process. As depicted by box 318, the website may initiate a count-down of a prescribed time period once the first user enters the bid process and may display the countdown to encourage users to purchase the item before the time expires. If no user elects to purchase the item at the current reduced price before expiration of the time period, the computer system may terminate the bid process. In a similar embodiment, each user who enters the bid process may be given a select amount of time to buy the item before others are allowed to buy it. For example, a user who enters a bid may be given 30 seconds measured from the time he or she paid the entry fee to purchase the item. During this 30 second period, only that user may purchase the item. After the 30 second period expires, any user who previously entered the bid process and/or new users who enter the bid process may purchase the item.

Although the invention has been described with reference to the preferred embodiment illustrated in the attached drawing figures, it is noted that equivalents may be employed and substitutions made herein without departing from the scope of the invention as recited in the claims. For example, the entry fee discussed in paragraph 32 does not have to be a fixed amount or fixed percentage. In another embodiment, the entry fee may be scaled so that it changes according to the number of users who enter the bid process for the same item. For example, the first 10 users who enter the bid process may be required to pay an entry fee of $10, the second 10 users may pay $9, the third 10 users may pay $8, etc. In yet another embodiment, the entry fee may be randomly selected from a range of possible values by the website. For example, the range for the entry fee may be $1-$10, and the website may randomly select a fee of $4 for one user, $9 for a second user, $2 for a third user, etc. In yet another embodiment, the entry fee may go up or down per a pattern as users enter the bid process for the same item. For example, the first user who enters the bid process may be required to pay an entry fee of $10, the second may pay $9, and the third users may pay $8, and then the pattern may repeat so that the fourth user may $10, the fifth may pay $9, and the sixth user may pay $8, etc.

Having thus described the preferred embodiment of the invention, what is claimed as new and desired to be protected by Letters Patent includes the following:

1. A non-transitory computer readable medium with a computer program stored thereon for controlling operation of a computer system to implement the following steps:
a) implementing a website with the computer system or another computer system in communication with the computer system and permitting users to access the website;
b) presenting to the users, via the website, information about a plurality of items, the information including at least a description and an initial price for each item;
c) permitting a user to select an item from the website and enter a bid process for the selected item;
d) receiving an entry fee from the user for the bid process;
e) deducting at least a portion of the entry fee from the initial price of the selected item to determine a reduced price for the selected item;
f) displaying the reduced price for the selected item on the website;
g) repeating steps (c)-(f) each time another user enters the bid process for the selected item; and
h) permitting any one, but only one, of the users who entered the bid process and paid the entry fee to purchase the selected item at the reduced price.

2. The non-transitory computer readable medium as set forth in claim 1, wherein the computer program is further operable to remove the item from the bid process if one of the users who entered the bid process and paid the entry fee elects to purchase the product at the reduced price.

3. The non-transitory computer readable medium as set forth in claim 1, wherein the computer program is further operable to remove the item from the bid process if none of the users who entered the bid process and paid the entry fee elect to purchase the item at the reduced price within a prescribed time period.

4. The non-transitory computer readable medium as set forth in claim 1, wherein the computer program is further operable: to remove the item from the bid process if none of the users who entered the bid process and paid the entry fee elect to purchase the item at the reduced price within a prescribed time period; and refund the entry fee to each user who entered the bid process.

5. The non-transitory computer readable medium as set forth in claim 1, wherein the entry fee is a percentage of the initial price of the selected item.

6. The non-transitory computer readable medium as set forth in claim 1, wherein the entire entry fee is deducted from the initial price of the selected item each time a user enters the bid process and pays the entry fee.

7. The non-transitory computer readable medium as set forth in claim 1, wherein the entire entry fee plus an additional bonus amount is deducted from the initial price of the selected item each time a user enters the bid process and pays the entry fee.

8. The non-transitory computer readable medium as set forth in claim 1, wherein the displaying step displays the reduced price only to the users who entered the bid process.

9. The non-transitory computer readable medium as set forth in claim 1, wherein the displaying step displays the reduced price to all the users who access the website so as to encourage all the users to enter the bid process to further reduce the reduced price of the selected item.

10. A computer-implemented method of selling products via the Internet or another communications network comprising the steps of:
a) implementing a website with a computer system;
b) permitting users to access the website via the Internet or other communications network;
c) presenting, via the website, product information about a plurality of products to the users, the product information including at least a description and an initial price for each product;
d) permitting a user to select a product and enter a bid process for the selected product;
e) receiving an entry fee from the user for the bid process;
f) deducting at least a portion of the entry fee from the initial price of the selected product to determine a reduced price for the selected product;
g) displaying the reduced price for the selected product on the website;
h) repeating steps (d)-(g) each time another user enters the bid process for the selected product; and
I) permitting any of the users who entered the bid process and paid the entry fee to purchase the selected product at the reduced price.

11. The method as set forth in claim 10, further comprising the step of removing the product from the bid process if one of the users who entered the bid process and paid the entry fee elects to purchase the product at the reduced price.

12. The method as set forth in claim 10, further comprising the step of removing the product from the bid process if none of the users who entered the bid process and paid the entry fee elect to purchase the product at the reduced price within a prescribed time period.

13. The method as set forth in claim 10, further comprising the steps of removing the product from the bid process if none of the users who entered the bid process and paid the entry fee elect to purchase the product at the reduced price within a prescribed time period; and refund the entry fee to each user who entered the bid process.

14. The method as set forth in claim 10, wherein the entry fee is a percentage of the initial price of the selected product.

15. The method as set forth in claim 10, wherein the entire entry fee is deducted from the initial price of the selected product each time a user enters the bid process and pays the entry fee.

16. The method as set forth in claim 10, wherein the entire entry fee plus an additional bonus amount is deducted from the initial price of the selected product each time a user enters the bid process and pays the entry fee.

17. The method as set forth in claim 10, wherein the displaying step displays the reduced price only to the users who entered the bid process.

18. The method as set forth in claim 10, wherein the displaying step displays the reduced price to all the users who access the website so as to encourage all the users to enter the bid process to further reduce the reduced price of the selected product.

19. A computer-implemented method of selling products via the Internet or another communications network comprising the steps of:
a) implementing a website with a computer system;
b) permitting users to access the website via the Internet or other communications network;
c) presenting, via the website, product information about a plurality of products to the users, the product information including at least a photo or image of each product, a description of each product, and an initial price for each product;
d) permitting a user to select a product and enter a bid process for the selected product;
e) initiating a count-down of a prescribed time period once the user enters the bid process;
f) receiving an entry fee from the user for the bid process;
g) deducting some but not all of the entry fee from the initial price of the selected product to determine a reduced price for the selected product;
h) displaying the reduced price for the selected product on the website to all users who access the website;
I) repeating steps (f)-(h) each time another user enters the bid process for the selected product;
j) displaying on the website information representative of the countdown;
k) permitting any one, but only one, of the users who entered the bid process and paid the entry fee to purchase the selected product at the reduced price within the prescribed time period;
l) removing the selected product from the bid process if one of the users who entered the bid process and paid the entry fee elects to purchase the selected product at the reduced price during the prescribed time period; and
m) removing the product from the bid process if none of the users who entered the bid process and paid the entry fee elect to purchase the product at the reduced price within the prescribed time period.

20. The method as set forth in claim 19, wherein the entire entry fee plus an additional bonus amount is deducted from the initial price of the selected product each time a user enters the bid process and pays the entry fee.
